(19) United States
(12) Patent Application Publication
(10) Pub. No.: US 2019/0012875 A1
(43) Pub. Date: Jan. 10, 2019

(54) CASINO DATA MANAGEMENT SYSTEMS AND METHODS OF OPERATING SAME

(71) Applicant: Konami Gaming, Inc., Las Vegas, NV (US)

(72) Inventors: Jeffrey George, Las Vegas, NV (US); Hoang Thai Nguyen, Las Vegas, NV (US)

(21) Appl. No.: 15/643,300

(22) Filed: Jul. 6, 2017

(51) Int. Cl. G07F 17/32; G06Q 50/34; G06F 17/30

(52) U.S. Cl. CPC G07F 17/3232; G06Q 50/34; G06F 17/30129; G07F 17/3223; G07F 17/3241; H04L 67/02; G07F 17/3293; G07F 17/329; G07F 17/3213; G07F 17/3246; G07F 17/3288

(57) ABSTRACT

A casino management system is described herein. The system includes an API server computer coupled to a plurality of business service systems and a plurality of gaming machines. The API server computer receives an HTTP request from a gaming machine including a URL including a resource request including a business service identifier and a resource object. The API server computer identifies a business service system associated with the business service identifier and transmits an API call to the identified business service system. The API server computer receives resource object data from the identified business service system in response to the transmitted API call and generates and transmits a return response including the received resource object data to the gaming machine that causes the gaming machine to generate HTML code to a webpage including the resource object data.

### FIELD OF THE DISCLOSURE

The present invention relates to software components, and more particularly, to systems, methods, and computer-readable storage media for use in operating a casino data management system.

### BACKGROUND

The growth and competition in the casino gaming market in recent years has resulted in an increase in the amount of patrons visiting the gaming establishments and the number of gaming devices available for play. Gaming machines, such as slot machines, have become a cornerstone of the gaming industry. In addition, casino operators have expanded the services being offered to patrons such as providing restaurants, shows, retail, and other forms of entertainment within the gaming property to appeal the gaming patron.

Known gaming establishments, such as casinos, use casino staff such a casino hosts or casino floor employees to assists patrons in obtaining the additional services being provided by the casino's. Because known casinos use staff members to assist patrons, the cost of providing these additional entertainment offerings are significantly increased. In addition, because of the limited number of casino employees available to assist patrons, casino patrons may become frustrated and device not to purchase any additional services offered by the casino. Accordingly, new features are necessary to improve on computer functionality to enhance patron's access to these services offered by the casinos.

Developing new webpages and functionality to support additional products and services and to utilize emerging user technologies presents significant challenges in developing new websites and website functionality. Accordingly, it is desired to provide an improved computer server system that supports the development of software applications that are consistent, reliable, and follow the most scalable development practices, as well as support consistent webpage builds and deployments across projects.

The present invention is aimed at one or more of the problems identified above.

### SUMMARY OF THE INVENTION

In different embodiments of the present invention, systems, methods, and computer-readable storage media implement a casino data management system.

In one embodiment of the present invention, a casino data management systems is provided. The system includes an application program interface (API) server computer coupled to a plurality of business service systems and a plurality of gaming machines. Each business service system includes a business service server computer coupled to a resource database. Each gaming machine includes a processor coupled to memory device having a web browser program installed thereon. The API server computer includes a processor coupled to a memory device including a data library stored thereon. The data library including a plurality of API calls associated with data resources stored in the plurality of business service systems. The API server computer receives a Hypertext Transfer Protocol (HTTP) request from a gaming machine. The HTTP request includes a Uniform Resource Locator (URL) including a resource request including a business service identifier and a resource object. The API server computer identifies a business service system associated with the business service identifier included in the URL and transmits an API call to the identified business service system as a function of the resource object. The API server computer receives resource object data from the identified business service system in response to the transmitted API call and generates and transmits a return response including the received resource object data to the gaming machine. The return response includes instructions that cause a web browser program of the gaming machine to generate HTML code for use in displaying a webpage including the resource object data on a display device of the gaming machine.

In another embodiment of the present invention, a method for operating a casino management system is provided. The casino management system includes a plurality of business service systems and an API server computer. Each business service system including a business service server computer coupled to a resource database. The API server computer is coupled to each of the business service systems and to a plurality of gaming machines. Each gaming machine includes a processor coupled to memory device having a web browser program installed thereon. The API server computer includes a processor coupled to a memory device including a data library stored thereon. The data library includes a plurality of API calls associated with data resources stored in the plurality of business service systems. The method including the API server computer receiving an HTTP request from a gaming machine. The HTTP request including a URL including a resource request including a business service identifier and a resource object. The API server computer identifies a business service system associated with the business service identifier included in the URL and transmits an API call to the identified business service system as a function of the resource object. The API server computer receives resource object data from the identified business service system in response to the transmitted API call and generates and transmits a return response including the received resource object data to the gaming machine. The return response includes instructions that cause a web browser program of the gaming machine to generate HTML code for use in displaying a webpage including the resource object data on a display device of the gaming machine.

In yet another embodiment of the present invention, one or more non-transitory computer-readable storage media, having computer-executable instructions embodied thereon is provided. The computer-executable instructions cause the processor to function as an API server computer coupled to a plurality of business service systems and to a plurality of gaming machines. Each gaming machine includes a processor coupled to memory device having a web browser program installed thereon. The API server computer includes a processor coupled to a memory device including a data library stored thereon. The data library includes a plurality of API calls associated with data resources stored in the plurality of business service systems. The API server computer receives an HTTP request from a gaming machine. The HTTP request includes a URL including a resource request including a business service identifier and a resource object. The API server computer identifies a business service system associated with the business service identifier included in the URL and transmits an API call to the identified business service system as a function of the resource object. The API server computer receives resource object data from the identified business service system in response to the transmitted API call and generates and transmits a return response including the received resource object data to the gaming machine. The return response includes instructions that cause a web browser program of the gaming machine to generate HTML code for use in displaying a webpage including the resource object data on a display device of the gaming machine.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic view illustrating various aspects of a data management system, according to the present disclosure;

FIG. 2 is another schematic example of components of the data management system shown in FIG. 1;

FIG. 3 is a schematic illustrating example of components of a server computer that may be used with the system shown in FIG. 1, according to an embodiment of the present invention;

FIG. 4 is a perspective view of a gaming device that may be used with the data management system show in FIGS. 1 and 2, according to an embodiment of the present invention;

FIG. 5 is a schematic illustrating example components of the gaming device shown in FIG. 4, according to an embodiment of the present invention;

FIG. 6 is a flowchart of a method of operating the system shown in FIGS. 1-2, according to an embodiment of the present invention;

FIG. 7-16 are illustrations of exemplary screenshots that may be generated by the system shown in FIGS. 1-2, according to embodiments of the present invention;

FIG. 17 is an illustration of exemplary computer software code generated by the system shown in FIGS. 1-2, according to embodiments of the present invention; and

FIGS. 18-21 are illustrations of exemplary data records generated by the system shown in FIGS. 1-2, according to embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In general, the present invention includes a casino data management system 10 that implements a REST API software architecture that enables the system 10 to provide casino data management services to a plurality of client devices including gaming machines located in a gaming casino. The system 10 includes an API computer server that includes programs that comprise a set of routines, protocols, and tools for building software applications that may be used by the client devices to access information being stored on one or more business service systems. The API computer server is programmed to express a software component in terms of its operations, inputs, outputs, and underlying types, allowing 3^{rd} party applications to access the business components/rules without gaining direct access to the interworking of SYNKROS™ casino data management system (CMS). The REST API software architecture makes it easier to develop a client device software programs by providing all the building blocks, which a programmer then puts the blocks together in developing the client side application. The system 10 allows for simplified development of Front End graphical user interfaces (GUI) that are executed by the client devices to access information stored in the business service systems.

The casino data management system 10 provides for lightweight Graphical User Interface (GUI) on the client devices. The end user application serves as a graphical user interface only, with all data processing being accomplished by the API computer server and business service systems. The system 10 enable easy expansion of data services, since the business service system layer elements are arranged in dedicated components, additional business rules and APIs to access them can be added quickly to the API server computer. The system 10 provides a scalable solution based on the usage, with API calls exposed on an as-needed basis. The system 10 reduces the need for expensive front end workstations and can be scaled on the server side to handle the workload. The system 10 enables incremental implementation of business service systems such as SYNKROS™ casino management systems, Super Series™ casino floor-wide bonusing system, and Konetic Mobile™ data management system can all be migrated to implement and use the API model. The system 10 also enables 3^{rd} Party integrations, by providing a robust API, that enables customers to use 3^{rd} party resources to customize GUI or to provide one-off development efforts without affecting existing customers. The system 10 also enables client devices to implement additional 3^{rd} Party APIs that have their own supported API.

In one embodiment, the system 10 implements the same API layer that can service Synkros™ Casino Management System GUI, Konetic™ Mobile Application GUI for use in conjunction with the Synkros™ CMS to receive and transmit data to the Synkros™ CMS in the mobile application, 3^{rd} Party API or Business Layer, etc. For instance, the patron signup screen API can be accessed from one or client devices using a Synkros™ CMS GUI Patron Services Screen, Konetic™ Mobile Application Patron Signup Screen, True-Time Windowing™ at the SYNKBox™ Employee Login—Patron Signup Screen (shown in FIG. 13), and/or a 3^{rd} Party client—Patron Signup Screen. The system 10 allows the customer to either develop their own GUI screens attached to the API or allow them to modify the GUI screen provided in Synkros™ Lightweight GUI screens can be built dynamically based on the API requirements. Lightweight GUI Screens can automatically resize based on the visual footprint of the hardware such as a desktop computer monitor, iPad/Android/Windows Tablets, Smart Phone, Etc. The system 10 also enables GUI to be on any Operating System Platform such as, for example, MS Windows, Linux, iOS, Android, etc. In addition, the system 10 enables workstation requirements to be reduced due to the light weight client. All client device touch points to the system 10 will be able to take advantage of the built in M-Que (Message queueing services) without multicast networking restrictions such as, for example, screen update notifications, callback notifications, security policies/role change notification, and/or remote approvals. The system 10 enables lightweight API driven User Interface (UI) screens that can be invoked at the True Time Display™ or True Time Windowing™ (Picture in Picture) at the Electronic Gaming Machine (EGM). These UI screens can utilize Synkros™ API, 3rd Party API, or a combination of both. For example, the True-Time Windowing™ with Picture-in-Picture EGM UI enables the blending of interactive content and services from the gaming machine and one or more independent sources, such as the CMS player tracking, services from the API server computer, and/or and 3rd party API.

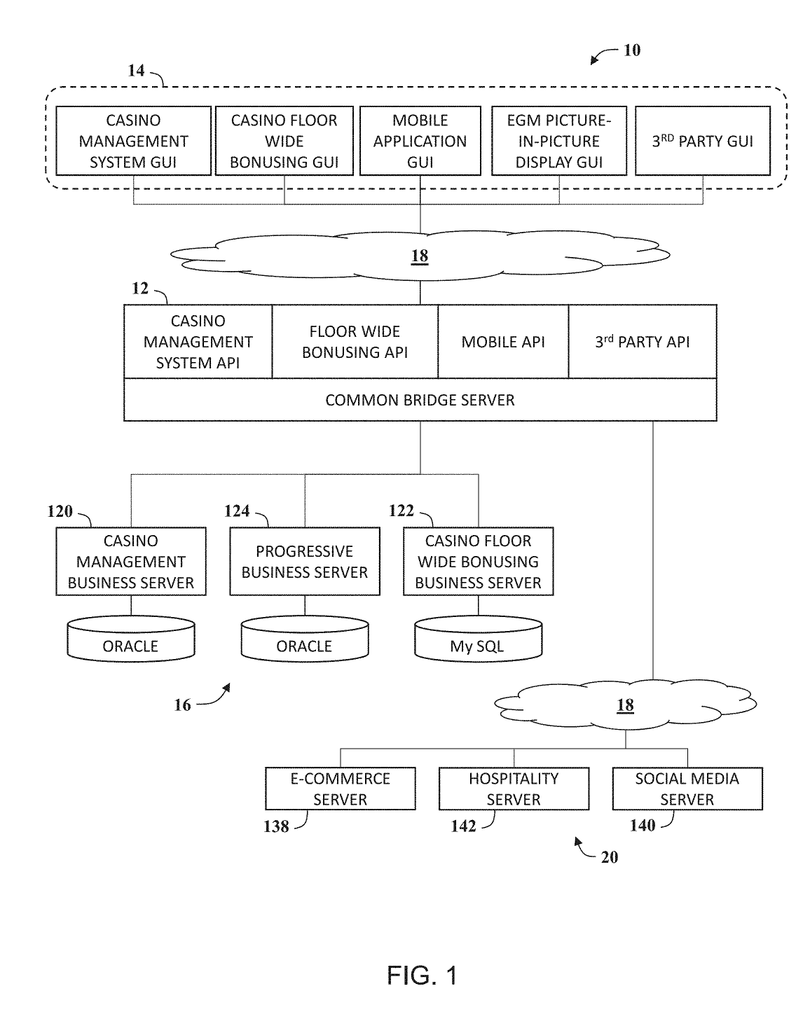

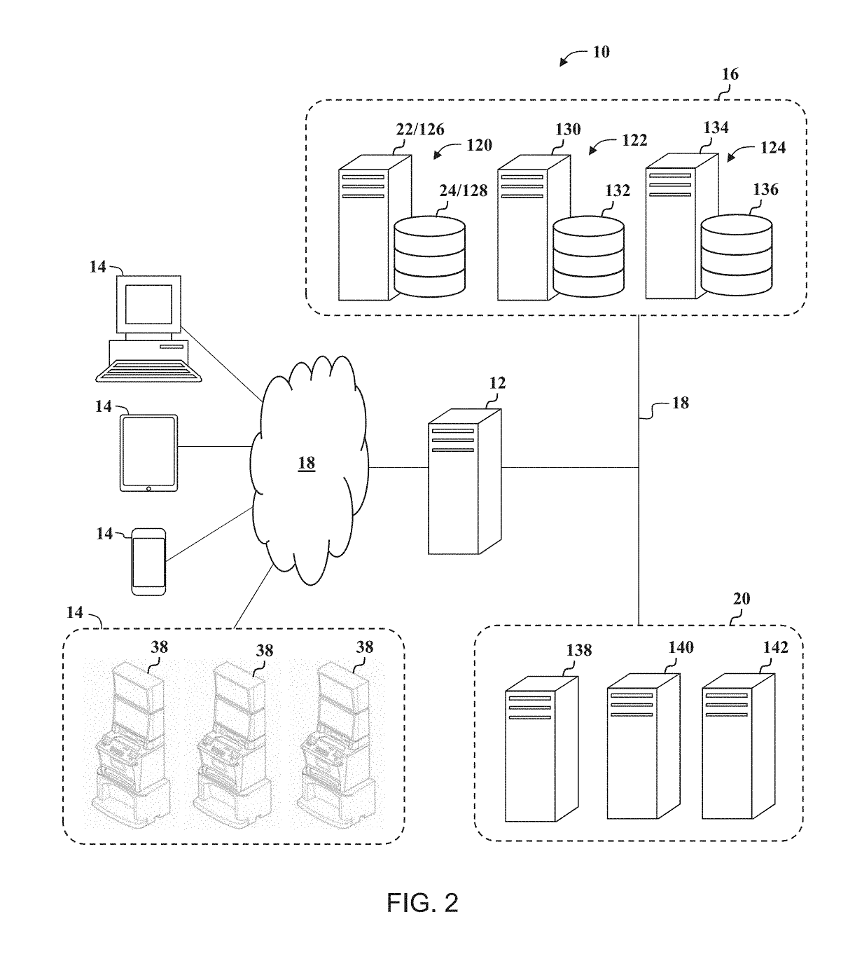

Referring to FIGS. 1 and 2, in the illustrated embodiment, the casino data management system 10 includes an API server computer 12 that is coupled in communication with a plurality of client computing devices 14 and a plurality of business service systems 16 via a communications network 18. In one embodiment, the business service systems 16 are configured to provide casino management services such as, for example, player account management, player tracking, gaming table management, slot machine management, casino floor-wide bonus award services, and/or casino progressive award management. In one embodiment the API server computer 12 may also be coupled to one or more 3^{rd} party server systems 20 that are configured to provide web-based services such as, for example, e-commerce websites, social media websites, hotel services, restaurant services, etc.

Each business service system 16 includes one or more business service server 22 that are coupled to a resource database 24. Each server may include one or more server computers that each include a processing device that includes a processor that is coupled to a memory device. The processing device executes various programs, and thereby controls components of the server according to user instructions received from the API server computer 12. The processing device may include memory, e.g., read only memory (ROM) and random access memory (RAM), storing processor-executable instructions and one or more processors that execute the processor-executable instructions. The processing device may also include a memory device for storing programs and information in one or more databases, and retrieving information from the databases that is used by the processor to perform various functions described herein. The memory device may include, but is not limited to, a hard disc drive, an optical disc drive, and/or a flash memory drive.

The communications network 18 may be any suitable connection, including the Internet, file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed.

The client computing devices 14 may include any suitable device that includes a display device configured to display websites to the user and a user input device, such as, for example, a keyboard and/or mouse, that enables a user to access and communicate with the system 10 including sending and/or receiving information to and from the system 10 and displaying information received from the system 10 to a user. The client computing device 14 may include a processing device that includes a processor that is coupled to a memory device. The processing device executes various programs, and thereby controls components of the client computing device 14 according to user instructions received via the user input device and/or server computers. For example, in one embodiment, the client computing device 14 may include, but is not limited to, a desktop computer, a laptop or notebook computer, a tablet computer, smartphone/tablet computer hybrid, a personal data assistant, a handheld mobile device including a cellular telephone, and the like. In addition, the client computing device 14 may include a touchscreen that operates as the display device and the user input device. In the illustrated embodiment, the client computing device 14 includes a web-browser program that is stored in the memory device. When executed by the processor of the client computing device, the web-browser program enables the client computing device to receive software code from the API server computer 12 including, but not limited to HTML, JavaScript, cascade style sheets (CS S), and any suitable programming code that enables the client computing device 14 to generate and display graphical interfaces including a website and/or webpages on the display device of the client computing device. The web-browser program also enables the client computing device 14 to receive instructions from the API server computer 12 that enable the client computing device 14 to render HTML code for use in generating and displaying portions of the website and/or webpage.

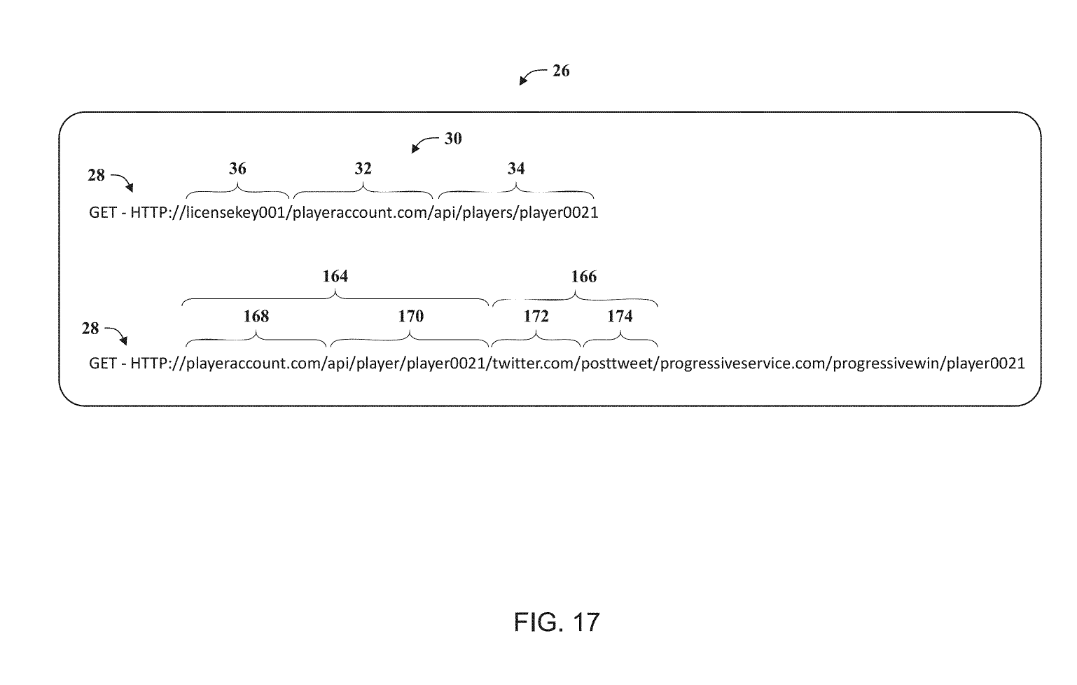

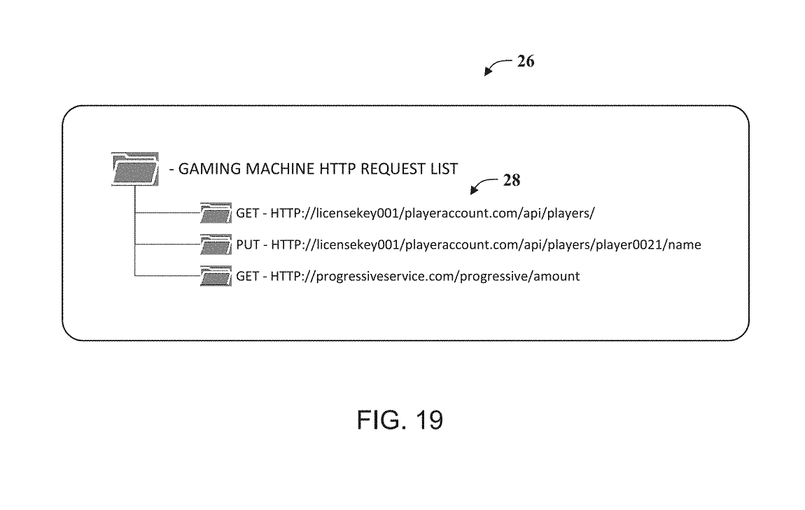

In the illustrated embodiment, the each client computing device 14 may include an HTTP list 26 (shown in FIGS. 17 and 19) stored on the memory device of the client computing device 14. The HTTP list 26 includes a plurality of Hypertext Transfer Protocol (HTTP) code requests 28 that are used to transmit data requests to the API server computer 12. In the illustrated embodiment, the HTTP list 26 includes a plurality of HTTP requests 28 including, for example, GET, POST, PUT, and/or any suitable HTTP request that may be used by the system 10 to function as described herein. Referring to FIG. 17, in one embodiment, each HTTP request 28 includes a Uniform Resource Locator (URL) that includes one or more resource requests 30 that includes a unique business service identifier 32 and a resource object 34. The resource request 30 is used by the API server computer 12 to access and retrieve information being stored and/or generated by the business service systems 16 and/or the 3rd party server systems 20. The business service identifier 32 is used by the API server computer 12 to identify a business service system 16 and/or 3^{rd} party server system 20. The resource object 34 includes information associated with a data object that is stored in and/or generated by the business service system 16 and/or 3rd party server system 20. In one embodiment, an HTTP request 28 may include a URL including a plurality of resource requests 30 each including a different business service identifier 32 and resource object 34. In one embodiment, the HTTP request 28 may also include a license key 36 that may be used by the API server computer 12 to limit information that is available from the business service systems 16 to the client computing devices 14 as described herein.

The client computing devices 14 receive and transmits information to and from the API server computer 12 and displays the graphical interfaces to enable the user/player to interact with the API server computer 12 to access a player tracking account, access casino services, and purchase goods and/or services from the business service systems 16 and/or the 3^{rd} party server system 20 in accordance with the embodiments described herein.

In the illustrated embodiment, the API server computer 12 is programmed to receive an HTTP request from a client computing device 14, identify a business service system 16 associated with the business service identifier included in the URL, and transmit an API call to the identified business service system as a function of the resource object. The API call transmitted to the business service system 16 causes the business service system 16 to retrieve and/or generate resource object data. The API server computer 12 receives resource object data from the identified business service system in response to the transmitted API call, and generates and transmits a return response to the client computing device 14 that includes received resource object data and instructions that cause a web browser program of the client computing device 14 to generate HTML code for use in displaying a webpage including the resource object data.

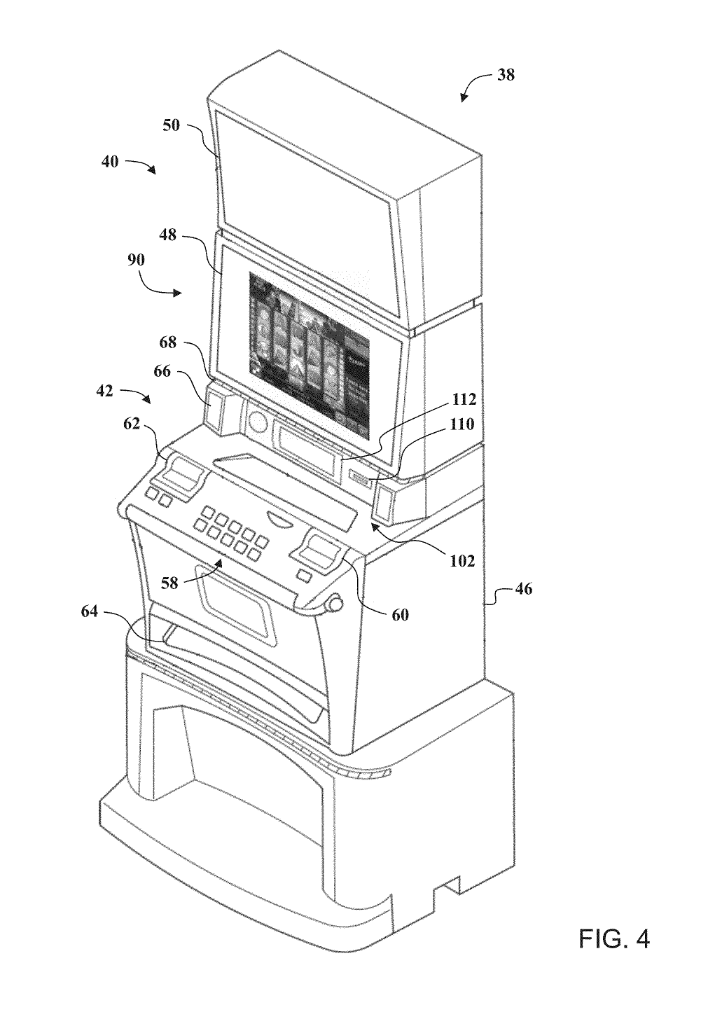

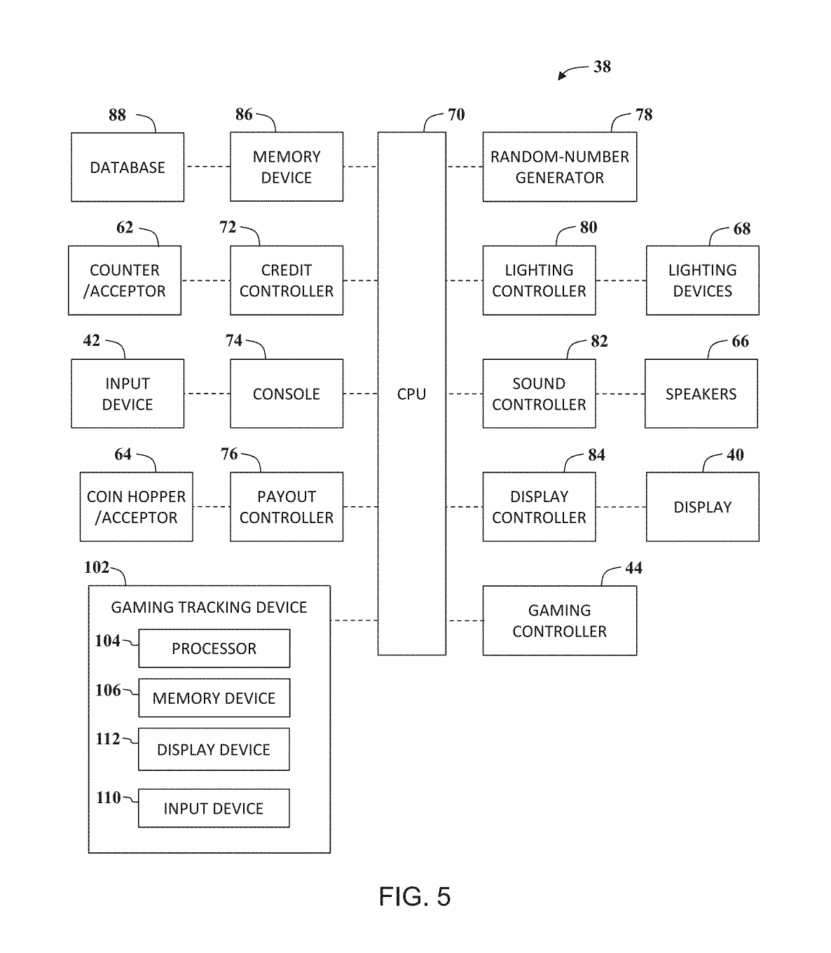

Referring to FIGS. 4 and 5, in the illustrated embodiment, one or more client computing devices 14 may include a gaming machine 38 located in a gaming casino. The gaming machine 38 includes a gaming display 40 for displaying a plurality of games, a user input device 42 to enable a player to interface with the gaming machine 38, and a gaming controller 44 that is operatively coupled to the gaming display 40 and the user input device 42 to enable a player to play games displayed on the gaming display 40. The gaming machine 38 also includes a cabinet assembly 46 that is configured to support the gaming display 40, the user input device 42, and/or the gaming controller 44 from a gaming stand and/or a supporting surface. The gaming display 40 includes, without limitation, a flat panel display, such as a cathode ray tube display (CRT), a liquid crystal display (LCD), a light-emitting diode display (LED), active-matrix organic light-emitting diode (AMOLED), a plasma display, and/or any suitable visual output device capable of displaying graphical data and/or text to a user. Moreover, the user input device 42 includes, without limitation, a keyboard, a keypad, a touch-sensitive screen, a scroll wheel, a pointing device, a barcode reader, a magnetic card reader, a radio frequency identification (RFID) card reader, an audio input device employing speech-recognition software, and/or any suitable device that enables a user to input data into the gaming controller 44 and/or to retrieve data from the gaming controller 44. Alternatively, a single component, such as a touch screen, a capacitive touch screen, and/or a touchless screen, may function as both the gaming display 40 and as the user input device 42.

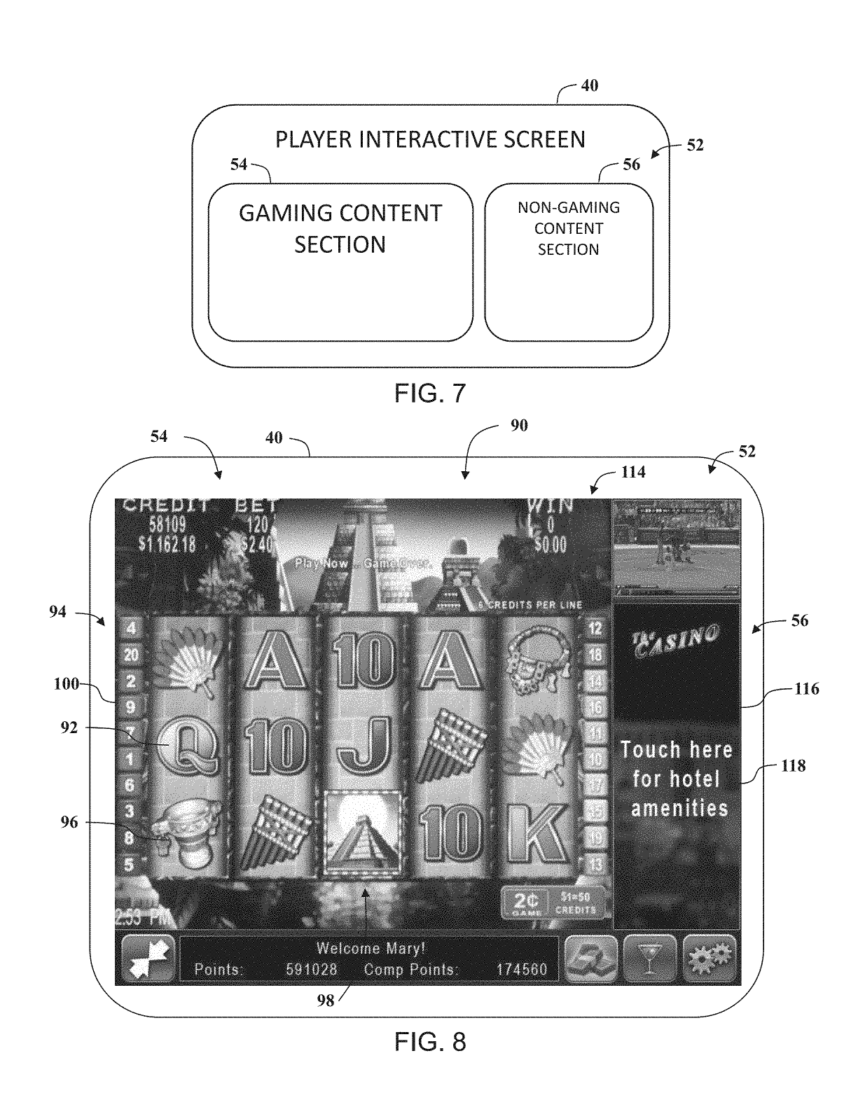

In one embodiment, the gaming display 40 includes a first display 48 and a second display 50. The first display 48 is configured to display a player interaction screen 52 (shown in FIGS. 7 and 8) including indicia and/or symbols for use in a game, e.g., cards used by a card game, roulette wheel and symbols used in a roulette game, and reels used in a reel game. The player interaction screen 52 may include any type of game including, but not limited to, a video slot game, a keno game, a blackjack game, a video poker game, or any type of game which allows a player to make a wager, play a game, and potentially provide the player an award based on an outcome of the game and a paytable. In one embodiment, the gaming machine 38 may be configured to display the player interaction screen 52 including a gaming content section 54 and a non-gaming content section 56 using a True Time Windowing™ picture-in-picture display. The gaming content section 54 is configured to display the reel game and the non-gaming content section 56 is configured to display a player interaction screen 52.

The second display 50 is configured to display game play instructions for performing the game including, but not limited to, playing instructions, paytables, paylines, betting lines and/or any other information to enable the gaming machine 38 to function as described herein. Moreover, each display 48 and 50 may be configured to display at least a portion of the player interaction screen 52 and/or game play instructions. In an alternative embodiment, the first display 48 and/or the second display 50 includes a plurality of mechanical reels displaying a plurality of game symbols.

The gaming display 40 and the user input device 42 are coupled to the cabinet assembly 46 and are accessible by the player. In one embodiment, the gaming controller 44 is positioned within the cabinet assembly 46. Alternatively, the gaming controller 44 may be separated from the cabinet assembly 46, and connected to components of the gaming machine 38 through a network such as, for example, a local area network (LAN), a wide area network (WAN), dial-in-connections, cable modems, wireless modems, and/or special high-speed Integrated Services Digital Network (ISDN) lines.

In one embodiment, the user input device 42 includes a plurality of input buttons 58, and one or more acceptor devices such as, for example, a coin slot 60, and/or a bill acceptor 62. The coin slot 60 includes an opening that is configured to receive coins and/or tokens deposited by the player into the gaming machine 38. The gaming machine 38 converts a value of the coins and/or tokens to a corresponding amount of gaming credits to establish a credit balance that is used by the player to wager on games played on the gaming machine 38.

The bill acceptor 62 includes an input and output device that is configured to accept a bill, a ticket, and/or a cash card into the bill acceptor 62 to enable an amount of gaming credits associated with a monetary value of the bills, ticket, and/or cash card to be credited to the gaming machine 38. Moreover, the gaming machine 38 may also utilize a cashless wagering system (not shown), such as a ticket in ticket out (TITO) system (not shown). In one embodiment, the bill acceptor 62 also includes a printer (not shown) that is configured to dispense a printed voucher ticket that includes information indicative of an amount of credits and/or money paid out to the player by the gaming machine 38 during a gaming session. The voucher ticket may be used at other gaming machines, or redeemed for cash, and/or other items as part of a casino cashless system (not shown).

A coin tray 64 is coupled to the cabinet assembly 46 and is configured to receive a plurality of coins that are dispensed from the gaming machine 38. One or more speakers 66 are installed inside the cabinet assembly 46 to generate voice announcements and/or sound effects associated with game play. The gaming machine 38 also includes one or more lighting devices 68 that are configured to blink and/or change brightness and color in specific patterns to produce lighting effects to enhance a visual gaming experience for the player.

In one embodiment, the input buttons 58 include a plurality of BET switches for inputting a wager on a game, a plurality of selection switches for selecting a betting line and/or card, a MAXBET switch for inputting a maximum wager, a PAYOUT switch for ending a gaming session and dispensing accumulated gaming credits to the player, and a start switch, i.e., a SPIN/DEAL button to initiate an output of a game.

In the illustrated embodiment, the BET switches include five switches from 1BET to 5BET to enable a player to wager between a minimum bet up to 5× minimum bet. Each selection switch corresponds to a betting line such as, for example, a payline and/or symbol for a reel game, one or more cards for a card game, and/or a symbol for a roulette game, to enable a player to associate a wager with one or more betting lines. The MAXBET switch enables a player to input the maximum bet that a player can spend against one play of a game. The PAYOUT switch enables a player to receive the amount of money and/or credits awarded to the player during a gaming session, which has been credited onto the gaming machine 38.

Referring to FIG. 5, in one embodiment, the gaming machine 38 includes a processor, i.e., a central processing unit (CPU) 70, the gaming controller 44, a credit controller 72, a console controller 74, a payout controller 76, a random-number generator (RNG) 78, a lighting controller 80, a sound controller 82, a display controller 84, a memory device 86, and a database 88. Memory device 86 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the CPU 70 to store, retrieve, and/or execute instructions and/or data.

The CPU 70 executes various programs, and thereby controls other components of the gaming machine 38 according to player instructions and data accepted by the user input device 42 and/or the gaming display 40. The gaming controller 44 in particular executes a game program, and thereby conducts a game in accordance with the embodiments described herein. The memory device 86 stores programs and databases used by the gaming controller 44. Moreover, the memory device 86 stores and retrieves information in the database 88 including, but not limited to, a game type, a number of reels associated with a game, a number of symbol positions being displayed on each reel, a type of symbols being displayed on each symbol position, a predefined set of normal symbols, a predefined set of special symbols, image data for producing game images and/or screens on the gaming display 40, and temporarily stores variables, parameters, and the like that are used by the gaming controller 44. In addition, the memory device 86 stores indicia, symbol weights, paytables, and/or winning combination tables which represent relationships between combinations of random numbers and types of awards. In one embodiment, the memory device 86 utilizes RAM to temporarily store programs and data necessary for the progress of the game, and EPROM to store, in advance, programs and data for controlling basic operation of the gaming machine 38, such as the booting operation thereof.

The credit controller 72 manages the amount of player's credits, which is equivalent to the amount of coins and bills counted and validated by the bill acceptor 62. The console controller 74 is coupled to the user input device 42 to monitor player selections received through the input buttons 58, and accept various instructions and data that a player enters through the input buttons 58. The payout controller 76 converts a player's credits to coins, bills, or other monetary data by using the coin tray 64 and/or for use in dispensing a credit voucher via the bill acceptor 62.

The lighting controller 80 controls one or more lighting devices 68 to blink and/or change brightness and color in specific patterns in order to produce lighting effects associated with game play. The sound controller 82 controls the speakers 66 to output voice announcements and sound effects during game play.

The RNG 78 generates and outputs random numbers to the gaming controller 44 preferably at the start of each round of a game. The gaming controller 44 uses the random numbers to determine an outcome of the game. For example, if the game is a video slot game, the gaming controller 44 uses the RNG 78 to randomly select an arrangement of symbols to be displayed on video reels. Moreover, the gaming controller 44 generally uses random numbers generated by the RNG 78 to play the games and to determine whether or not to provide an award to a player. In addition, the gaming controller 44 generates game outcomes including combinations of random numbers, and compares the generated combinations with winning combinations stored in the winning combination table to determine if the generated outcome is a winning outcome that is associated with a type of award.

The display controller 84 controls the gaming display 40 to display various images on screens preferably by using computer graphics and image data stored in the memory device 86. More specifically, the display controller 84 controls video reels in a game screen displayed on the first display 48 and/or the second display 50 by using computer graphics and the image data. The display controller 84 is connected to the gaming display 40 for receiving image data indicative of the player interaction screen 52 for use in displaying the player interaction screen 52 on the gaming display 40. In one embodiment, the gaming display 40 may be configured to perform the function and operation of the display controller 84 and may be housed within the gaming cabinet assembly 46 of the gaming machine 38. Moreover, the gaming display 40 may be connected directly to the gaming display 40 to control the gaming display 40 to display various images on screens preferably by using computer graphics and image data stored in the memory device 86.

In the illustrated embodiment, the gaming controller 44 executes a game program stored in the memory device 86 to generate and display a game 90 such, for example, a video slot game. However, it should be noted that the game 90 may be any type of game upon which a player could make a wager including, but not limited to, a keno game, a blackjack game, a video poker game, or any type of game that enables the system 10 to function as described herein. For example, in one embodiment, the gaming controller 44 may receive a signal indicative of a wager being placed by the player and responsively initiates a round of the game 90. Moreover, the gaming controller 44 randomly generates an outcome and generates and transmits game data indicative of the outcome to the gaming display 40. The gaming display 40 responsively displays the game outcome on the gaming display 40.

In the illustrated embodiment, the gaming controller 44 randomly selects a plurality of game symbols 92 from a predefined set of possible game symbols, and displays the selected game symbols 92 associated with the generated game outcome in the game 90. In one embodiment, the game symbols 92 are displayed in a grid 94 having a plurality of cells 96 arranged along a plurality of rows and a plurality of columns. Each cell 96 displays one or more game symbols 92 associated with the game outcome. In the illustrated embodiment, the gaming controller 44 displays the game symbols 92 within a plurality of reels 98. Each reel 98 is associated with a corresponding column. The game 90, in the illustrated embodiment, includes 5 reels 98 with 3 cells 96 per reel, respectively (a “5×3” arrangement). Alternatively, other reel arrangements may be used such as, for example, 3-4-3-4-3, 4-5-5-5-4, or 4-5-4-5-4 arrangements, or arrangements with the same number of cells per column, such as 3×3, 3×4, 4×5, or 5×5 configurations. The game 90 may also include a plurality of paylines 100 that extend across one or more cells 96 to indicate, to the player, a combination of game symbols.

In the illustrated embodiment, the gaming controller 44 receives a signal, from the user input device 42, that is indicative of a player's selection to initiate a gaming session including a wager amount, and a selection of one or more paylines 100 associated with a predefined set of cells 96. In the illustrated embodiment, the game 90 is a multi-line game, i.e., the paylines include horizontal paylines and/or diagonal pay-lines, and/or zig-zag paylines. Moreover, the user input device 42 may allow the player to toggle to increase the bet per payline a credit at a time (up to the maximum bet). The gaming controller 44 randomly generates an outcome of the game 90, and displays the generated outcome on the gaming display 40. In one embodiment, the gaming controller 44 is configured to rotate, and/or spin each reel 98 to initiate a game play, and stop each reel 98 to display a plurality of game symbols 92 associated with the randomly generated outcome. In addition, the gaming controller 44 is adapted to determine if the generated outcome is a winning outcome as a function of the displayed symbols 92, a paytable, a wager, and one or more player selected paylines 100. More specifically, the gaming controller 44 determines if a combination of symbols 92 arranged along the selected payline 100 is a winning combination. The gaming controller 44 may provide an award in response to the outcome of the game 90. If a predetermined pattern of symbols 92 is randomly chosen for each cell 96 on a played payline 100, the player may be awarded a payout based on the payline, the wager, and a predetermined paytable. Many variations to the above described general play of a slot game fall within the scope of the present invention. Such slot games are well-known in the art, and are therefore not further discussed.

In the illustrated embodiment, the gaming machine 38 also includes a gaming tracking device 102 that is coupled to the API server computer 12 and is configured to access player information, access casino services, and purchase goods and/or services from the business service systems 16 and/or the 3^{rd} party server systems 20 in accordance with the embodiments described herein.

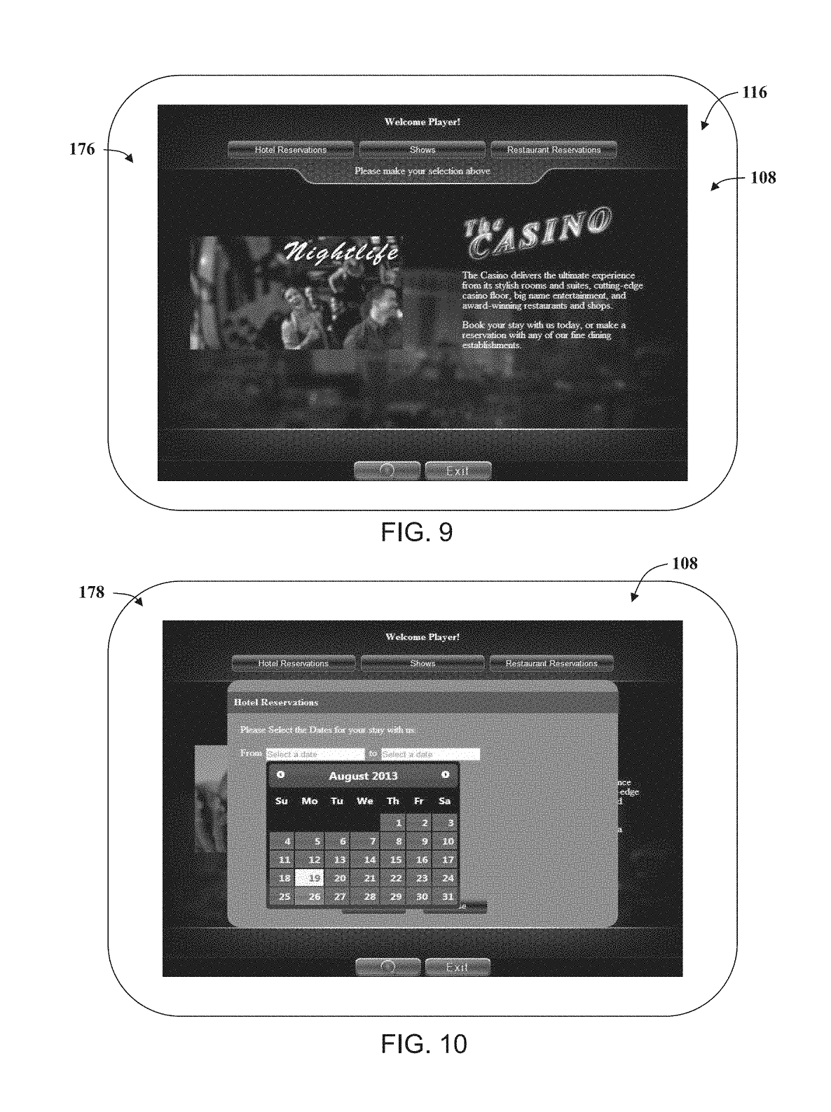

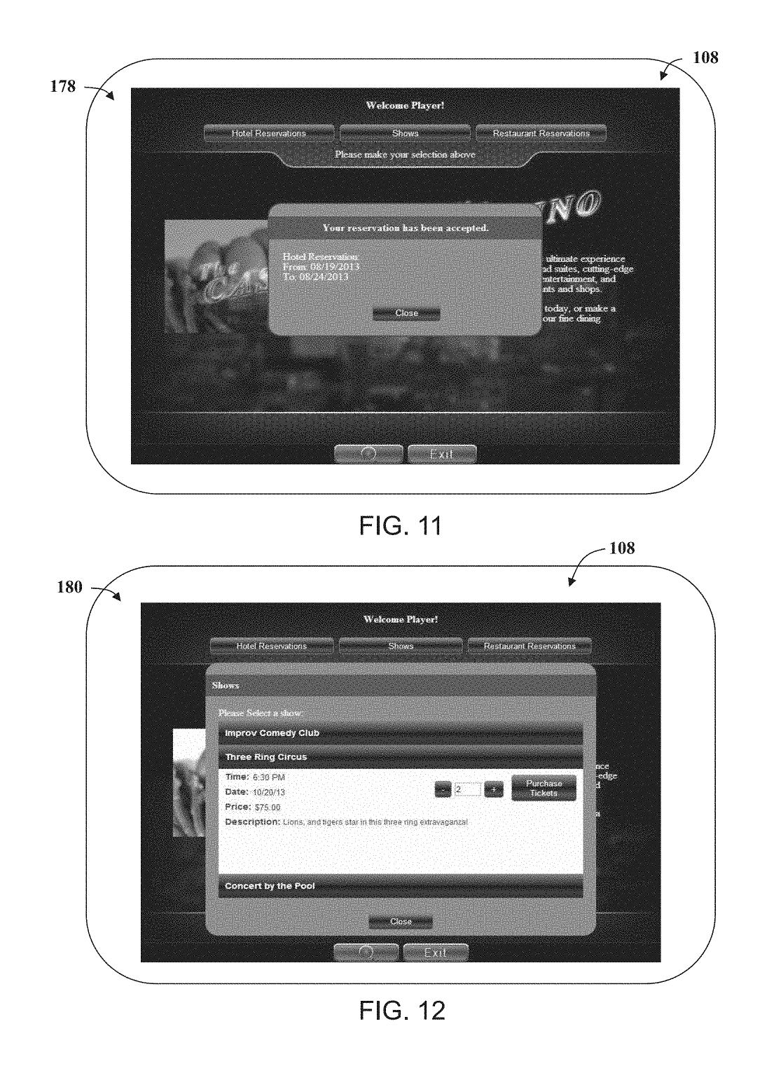

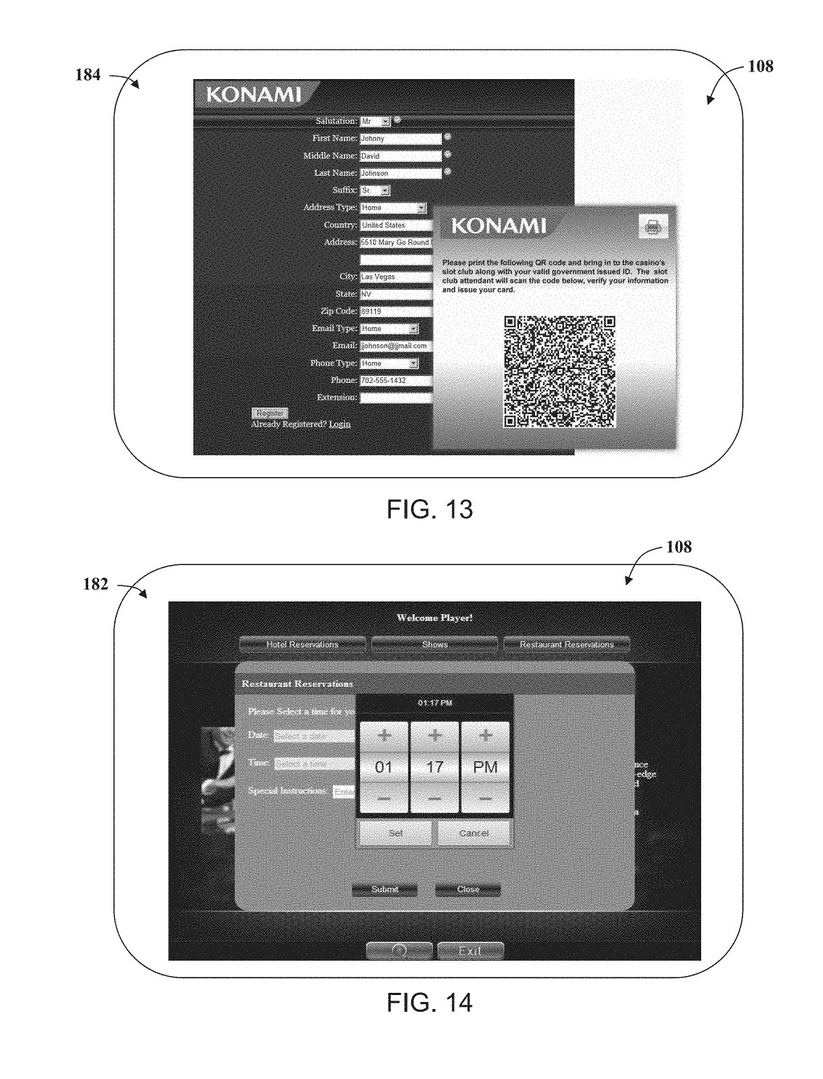

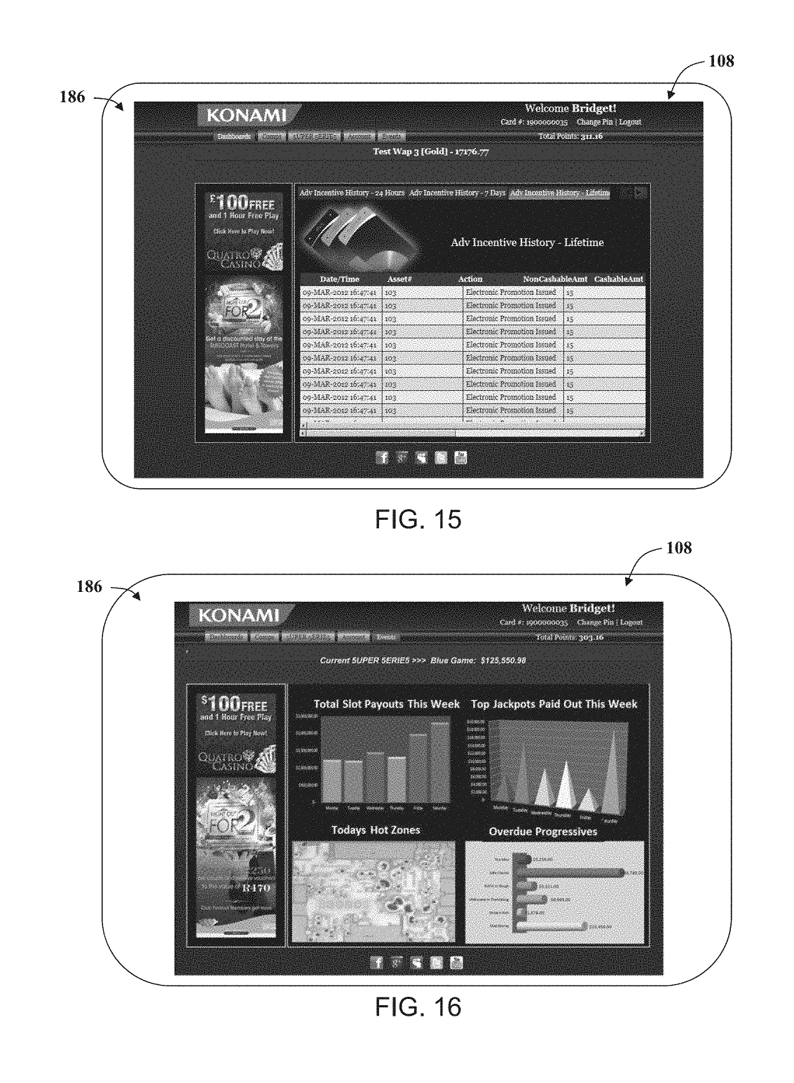

In the illustrated embodiment, the gaming tracking device 102 includes a processor 104 that is coupled to a memory device 106. The processor 104 includes a display module that includes a program that is configured to control and/or drive the gaming display 40 included with the gaming machine 38. The gaming tracking device 102 also includes a web browser program stored in the memory device 106 for use by the processor 104 to generate and display a web browser interface 108 (shown in FIGS. 8-16). The web browser interface 108 enables a player to access the gaming property services via a website being displayed on the gaming machine 38. The gaming tracking device 102 may also an input device 110 that includes player identification card reader and/or a numeric keypad, and a display device 112 that includes a video display and sound speakers. In one embodiment, the display device 112 may include a touchscreen panel that includes a numeric keypad. The gaming tracking device 102 may be used to identifying a player and/or gaming attendant to access player accounts and/or casino services from the gaming machine 38.

In the illustrated embodiment, the gaming tracking device 102 is configured to display a True Time Windows™ GUI 114 on the gaming machine 38 including the player interaction screen 52 including the gaming content section 54 and the non-gaming content section 56 using a True Time Windowing™ picture-in-picture display. Moreover, the player interaction screen 52 displays the game 90 being generated by the gaming controller 44 within the gaming content section 54 and displays a services website 116 in the non-gaming content section 56. More specifically, the display module is configured to receive game data indicative of game play from the gaming controller 44, receive services data indicative of the services web site 116 from the API server computer 12 and display the game and the gaming property services on the player interaction screen 52. In one embodiment, the gaming display 40 includes a touchscreen that relates player selections received via the touchscreen to the gaming tracking device 102 to enable the gaming tracking device 102 to allow the player to interact with the website via the touchscreen. Similarly, the gaming display 40 transmits player selections to the gaming controller 44 to enable the gaming controller 44 to conduct game play in response to player selections. In the illustrated embodiment, the gaming display 40 may adjust a size, orientation, and/or position of each of the gaming content section 54 and the non-gaming content section 56 based on the input received from the player. For example, in one embodiment, the gaming display 40 may allow the player to select a region on the touchscreen corresponding to the services website 116 being displayed in the non-gaming content section 56 and enlarge the non-gaming content section 56 to allow a larger portion of the services website 116 to be viewable to the player on the gaming display 40.

In one embodiment, the gaming tracking device 102 may display advertising information received from the business service systems 16 and/or the 3^{rd} party server system 20 in the non-gaming content section 56 of the player interaction screen 52. In addition, the gaming tracking device 102 may receive and display a live video broadcast image of a sporting event, gaming tournament, or special event provided by the business service systems 16 and/or the 3^{rd} party server system 20. In addition, the gaming tracking device 102 may display images indicative of bonus feature games, such as progressive games, slot tournaments, and/or system based awards that are received from the business service systems 16. In addition, the gaming tracking device 102 may display player information obtained from a player account associated with the player in the non-gaming content section 56.

The gaming tracking device 102 is configured to transmit and receive information from the API server computer 12 for use in displaying webpages on the gaming machine 38. In the illustrated embodiment, the gaming tracking device 102 includes the HTTP list 26 stored on the memory device 106 that is used to transmit and receive information from the API server computer 12. For example, in the illustrated embodiment, the gaming tracking device 102 is programmed to display a webpage on the gaming machine 38 that may be used by the player to access services and/or information provided by the business service systems 16 and/or the 3^{rd} party server systems 20. The webpages may be displayed with a plurality of hyperlinks that are associated with the HTTP requests 28 being stored in the HTTP list 26. When a player accesses a hyperlink being displayed on the webpage, the gaming tracking device 102 accesses the HTTP list 26 to determine the HTTP request associated with the player accesses hyperlink, and transmits the HTTP request 28 to the API server computer 12. Each HTTP request is associated with an action that may be performed by one or more business service systems 16 and/or 3^{rd} party server systems 20. The HTTP list 26 includes HTTP requests 28 that includes instructions that may be used to create a new player account, update an existing player tracking account, and/or request gaming property services such as, for example, hotel reservations, and/or restaurant reservations.

For example, Referring to in one embodiment, the gaming tracking device 102 may be programmed to display the True Time Windows™ GUI 114 (shown in FIG. 8) including a hotel services icon 118 associated with gaming property services. Upon selection of the hotel services icon 118, the processor of the gaming tracking device 102 may access the HTTP list 26 being stored in the memory device and select the HTTP request 28 associated with the hotel services icon 118 and transmit the HTTP request 28 to the API server computer 12. The gaming tracking device 102 may then receive data from the API server computer 12 and display the received data on the webpage. For example, in one embodiment, the gaming tracking device 102 may receive HTML code from the API server computer 12 and generate and display a gaming property services webpage 116 using the received HTML code.

In one embodiment, the gaming tracking device 102 may also transmit the HTTP request 28 including a unique player identifier associated with the player for use by the API server computer 12 to determine the gaming property services provided to the player as a function of the unique player identifier. Moreover, the gaming tracking device 102 may be configured to determine a unique machine identifier associated with the gaming machine 38 and transmit the HTTP request 28 including the unique machine identifier to enable the API server computer 12 to determine a location of the gaming machine 38 as a function of the unique machine identifier, and to determine the gaming property services being provided to the player as a function of the location of the gaming machine 38.

The gaming tracking device 102 may also monitor and track the property services being accessed by the player via the website, and generate and transmit an HTTP request including tracking data indicative of the player's activity and services accessed by the player to the API server computer 12 for use in storing the tracking data in a corresponding player account. Additional details of the gaming machine 38 and the gaming tracking device 102, which may be used in the present invention, are described in U.S. patent application Ser. No. 14/488,174 to Jeffrey D. George et al., now U.S. Pat. No. 9,619,962, filed Sep. 16, 2014, titled “System and Methods of Providing Player Services with Gaming Devices”, and described in U.S. patent application Ser. No. 12/235,237 to Edward Sepich et al., now U.S. Pat. No. 8,429,229, filed Sep. 22, 2008, titled “Multipurpose EGM/player Tracking Device and System”, which are incorporated herein by reference in their entirety.

Referring to FIGS. 1 and 2, in the illustrated embodiment, the business service systems 16 include player management system 120, a casino floor-wide bonusing system 122, and a progressive award system 124. The player management system 120 includes player management server 126 that is coupled to a player tracking database 128 that includes a plurality of player tracking accounts that include information associated with a plurality of players. In one embodiment, the player management server 126 may receive player tracking data from the gaming tracking device 102 and generates and stores the received player tracking data in corresponding player accounts stored in the database 128. In addition, the player management server 126 retrieves a player account and transmits the player tracking data in response to API calls received from the API server computer 12. Player tracking accounts may be used to store information associated with a patron include patron contact information such as an address, phone numbers, email, and/or social media accounts, a player's gaming activity including, but not limited to, gaming credits available to the player for use in playing the gaming machine, the player's play on the gaming machine, the player's overall play, and/or play during a predetermined period of time, the player's birthday or anniversary, or any other suitable information that enables the system to function as described herein.

In addition, the player management system 120 may be configured to provide accounting, monitoring, and/or other gaming related services, such as, ticking, progressives, gaming attending, and/or EGM interaction services, and provide a player additional services, such as, player tracking, points management, bonusing, multimedia content and/or entertainment services. For example, in one embodiment, the player management system 120 include an entertaining management and monitoring system that may include many additional functions such as real-time multi-site, EGM accounting, EGM monitoring, player tracking, cage credit and vault, sports book, Point of Sale (POS) accounting, keno accounting, bingo accounting, and table game accounting, a wide area progressive jackpot, and electronic funds transfer (EFT), as well as interfaces to other gaming and non-gaming systems. Two such systems are disclosed in U.S. patent application Ser. No. 11/094,605, filed Mar. 30, 2005, which is hereby incorporated by reference.

In the illustrated embodiment, the casino floor-wide bonusing system 122 includes a bonusing server computer 130 that is coupled to a jackpot account database 132. The bonusing server computer 130 includes a computer program that is configure to generate a floor-wide bonus game that establishes one or more jackpot pools for awarding prizes or jackpots to the players. The bonusing server computer 130 includes an accumulator program that is responsive to play at each of the gaming machines 38 by the players and accumulates funds within the one or more jackpot pool accounts that are stored in the jackpot account database 132. The funds are contributed to the jackpot pool(s) by the players through their playing of the primary game on the gaming machines 38. Therefore, funds are added to the jackpot pool(s) as a function of a wager by each player at the gaming machines 38. The prizes for the jackpot, which are established by the funds in the jackpot pool(s) within the accumulator program, may be cash, credits, coins, or any other prize known to those skilled in the art. The funds are added to the jackpot pool(s) as a function of a wager by each player multiplied by a predetermined percentage. In one embodiment, the funds are added to the jackpot pool(s) as a function of a wager by each player multiplied by a predetermined percentage.

For example, accumulator program is configured to allow the percentage contribution to be set by the casino for all gaming machines 38 or may be a percentage based on the type of gaming machine 38. Additionally, the predetermined percentage may be based on the theoretical hold or win of a gaming machine 38 or the profit (e.g., of a point of sale, table games, Keno, Bingo, Sports Book or other casino revenue sources connected to the system). As it pertains to the theoretical hold or win of a gaming machine, the predetermined percentage of gaming machines capable of a plurality of theoretical hold or win is the actual percentage of the active game the player is playing. In yet another embodiment, the funds are added to the jackpot pool(s) as a function of a historical average of wagers by each player multiplied by a predetermined percentage or a theoretical hold. The historical average and/or purchase may be a casino (single or multiple property) value and may be based on one or more of the following: casino, property, game or machine type, game or machine manufacturer, denomination of the game, player, player category or group, or any other criteria. Additional details of the casino floor-wide bonusing system 122, which may be used in the present invention, are described in U.S. patent application Ser. No. 11/779,537 to Jeffrey George et al., now U.S. Pat. No. 8,727,854, filed Jul. 18, 2007, titled “System and Method for Operating a Matching Game in Conjunction with a Transaction on a Gaming Machine”, which is incorporated herein by reference in its entirety.

The progressive award system 124 includes a wide-area progressive server 134 coupled to a progressive award database 136. The wide-area progressive server 134 includes a progressive jackpot controller that is programmed to contribute to a progressive jackpot award when a player plays a gaming machine and/or accesses their account and uses previously awarded bonus points. For example, in one embodiment, the jackpot controller establishes a user account in the database 136 to store user account data including bonus points associated with the player. The jackpot controller enables the player may access and use the incentive awards or bonus points in their user account on one of the gaming machines 38, by converting the bonus points into credits and wagering the credits or by exchanging the bonus points for gift(s) and/or service(s) or by exchanging the voucher for the specified gift or service.

The jackpot controller detects a random trigger event occurring with one or more gaming machine 38 and randomly selects one or more players to receive the progressive jackpot award. Additional details of the progressive award system 124, which may be used in the present invention, are described in U.S. patent application Ser. No. 11/066,753 to Thomas Soukup et al., now U.S. Pat. No. 7,883,410, filed Feb. 25, 2005, titled “System and Method for Establishing a Progressive Jackpot Award”, which is incorporated herein by reference in its entirety.

The 3^{rd} party server systems 20 may include an e-commerce website server 138, such as, for example, Amazon.com™, a social-media server system 140 such as, for example, Twitter.com™ and/or Facebook.com™, and/or a hotel/restaurant property server system 142.

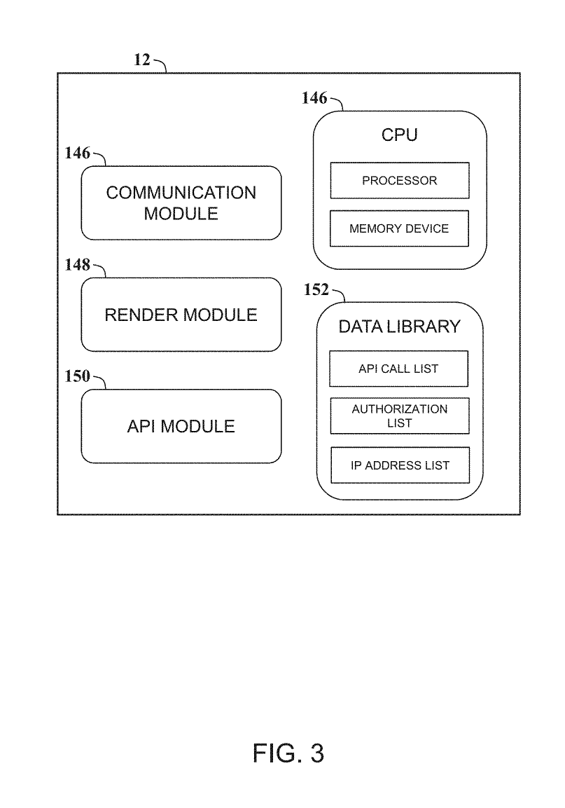

Referring to FIG. 3, in the illustrated embodiment, the API server computer 12 includes a central processing unit (CPU) 144 that includes a processor coupled to a memory device, a communication module 146, a render module 148, an API module 150, and a data library 152. The CPU 144 includes one or more processors that are coupled to a memory device that includes various programs that are executable by the processor. In addition, the CPU 144 executes various programs, and thereby controls components of the server computer 12 according to user instructions received from the client computing devices 14, the business service systems 16, and/or the 3^{rd} party server system 20 to enable users to interact with an operate the server computer 12. For example, in the illustrated embodiment, the processor is programmed to retrieve HTTP requests from the client computing devices 14 and access the data library 152 to retrieve API calls as a function of the HTTP requests, and transmit the API calls to one or more business service systems 16 and/or 3^{rd} party server systems 20 to retrieve resource object data included in the received HTTP requests. The processor may then generate a return response that includes rendered HTML code including the resource object data that may be transmitting to the client computing device 14 for use in generating and displaying a website and/or webpage on the client computing devices 14 using the web browser programmed installed on the client computing devices 14.

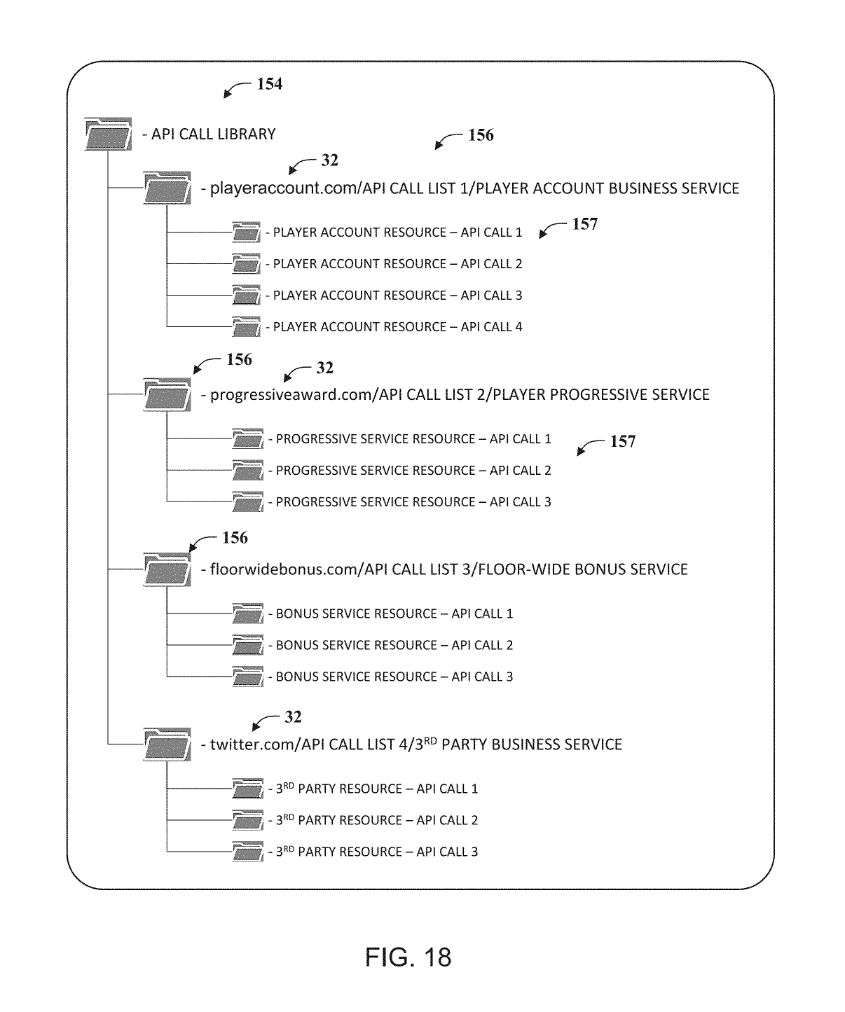

The data library 152 includes a plurality of data records that may be used by the API server computer 12 to execute the functions described herein. For example, referring to FIG. 18, in one embodiment the data library 152 includes an API call library 154 that includes a plurality of API call lists 156. Each API call list 156 includes a business service identifier 32 associated with the business service system 16 and/or 3^{rd} party server system 20 for use in identifying the API call list 156. Each API call list 156 includes a plurality of API calls 157 that are associated with a corresponding business service system 16 and/or 3^{rd} party server system 20. Each API call includes computer instructions that cause the corresponding business service system 16 and/or 3^{rd} party server system 20 to generate and transmit resource object data to the API server computer 12. For example, in one embodiment, an API call may include instructions that cause the player management server 126 to retrieve player account information from the player tracking database 128, and transmit the player account information to the API server computer 12. In another embodiment, an API call may include instructions that cause the player management server 126 to generate a new player account in the player tracking database 128. For example, in one embodiment, an API call list 156 may include a plurality of REST APIs available from a social media server system 140 such as, for example, Twitter™ available at https://dev.twitter.com/rest/public, and/or Facebook™ Graph API available at https://developers.facebook.com/docs/graph-api.

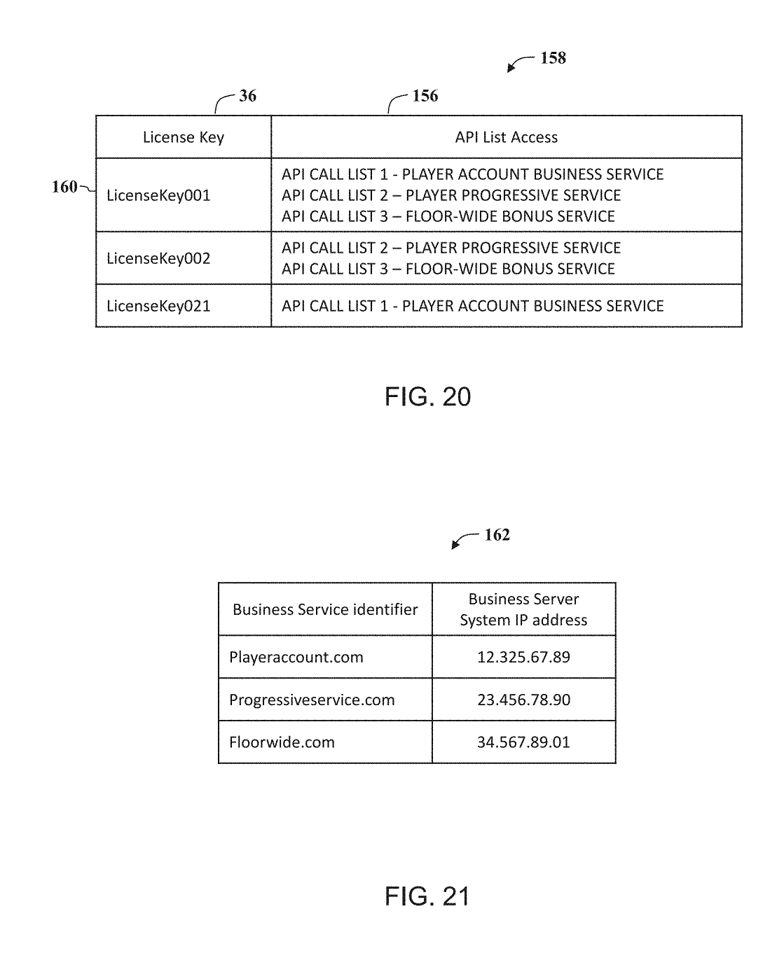

The data library 152 also includes an API authorization list 158 (shown in FIG. 20) that includes a plurality of authorization records 160. Each authorization record 160 includes a corresponding license key 36 and one or more API call lists 156 associated with the corresponding license key 36. The API authorization list 158 is used by the API server computer 12 to expose the API call lists 156 to the client computing devices 14 based on the license key 36 received in the HTTP requests.

In one embodiment, the data library 152 may also include an IP address list 162 that includes a plurality of IP addresses associated with each of the business service system 16 and/or 3^{rd} party server system 20. The IP address list 162 is used by the API server computer 12 to identify an appropriate IP address to transmit the API calls.

The communication module 146 is programmed to receive HTTP requests from the client computing devices 14 and transmit data including return responses to the client computing devices 14 via the communications network 18. In addition, the communication module 146 is programmed to transmit and receive data from the business service systems 16 and/or the 3^{rd} party server systems 20 via the communications network 18.

The render module 148 is programmed to receive resource object data from the API module 150 and generate an HTML code string that is transmitted to the client computing device 14 that may be used by the client computing device 14 to generate and display a webpage including the resource object data. For example, in one embodiment, the render module 148 may be configured to receive JSON code from the API module 150 including the resource object data received from the business service systems 16 and/or the 3^{rd} party server systems 20 and execute a render operation to generate the HTML code string that is then transmitted to the client computing device 14. In addition, the render module 148 may be configured to initiate the partial-render operation to execute the received JSON code to generate partially-rendered application code including JavaScript instructions to generate the HTML code using the received resource object data. For example, upon receiving the resource object data from the API module 150, the render module 148 may be programmed to generate and transmit JavaScript instructions and the resource object data to the client computing device 14. The JavaScript instructions cause the client computing device 14 to generate the rendered HTML code string for use in displaying the webpage including the resource object data.

The API module 150 is programmed to receive an HTTP request 28 from one or more client computing devices 14 including a resource object, identify the business service system 16 and/or a 3^{rd} party server system 20 associated with the resource object and transmit an API call to the identified business service system 16 and/or a 3^{rd} party server system 20. The API call causes the identified business service system 16 and/or a 3^{rd} party server system 20 to generate and transmit resource object data to the API module 150. Upon receiving the resource object data from the business service system 16 and/or a 3^{rd} party server system 20, the API module 150 transmits the resource object data to the render module 148 for use in generating a return response including the resource object data to the client computing device 14.

For example, the API module 150 is programmed to receive an HTTP request 28 (shown in FIG. 17) from a client computing device 14 including a URL including a resource request 30 including a business service identifier 32 and a resource object 34. The API module 150 identifies a business service system 16 and/or 3^{rd} party server system 20 associated with the business service identifier 32 included in the URL, and accesses the API call library 154 upon receiving the HTTP request 28 and identifies an API call list 156 associated with business service identifier 32. For example, upon receiving the HTTP request from the client computing device 14, the API module 150 identifies a business service system associated with the business service identifier included in the HTTP request and accesses the API call library upon receiving the HTTP request and identifies an API call list associated with the identified business service system. The API module 150 then accesses the identified API call list 156 and selects the API call 157 as a function of the resource request 30 and transmit the selected API call 157 to the identified business service system 16 and/or 3^{rd} party server system 20. For example, the API module 150 accesses the identified API call list 156 and selects the API call 157 as a function of the resource object 34 included the received HTTP request 28.

The API module 150 is also programmed to access the IP address list 162 upon receiving the HTTP request, identify an IP address associated with the identified business service system, and transmit the API call to the identified IP address associated with the identified business service system.

In one embodiment, the API module 150 may be programmed to determine if the received HTTP request 28 includes a license key 36 and accesses the API call list upon identifying the license key 36. For example, the API module 150 may be programmed to access the API authorization list 158 upon receiving the HTTP request 28 and determine if the identified API call list 156 is associated with the identified license key 36. The API module 150 may then transmit the selected API call 157 upon determining the identified license key 36 is associated with the selected API call list 156.

Referring to FIG. 17, in one embodiment the API module 150 may receive an HTTP request 28 that includes a first resource request 164 and a second resource request 166. The first resource request 164 including a first business service identifier 168 and a first resource object 170, and the second resource request 166 including a second business service identifier 172 and a second resource object 174. The API module 150 is programmed to identify a first business service system associated with the first business service identifier 168, access the API call library 154 and retrieve a first API call 157 associated with the first business service identifier 168 and the first resource object 170, and transmit the first API call to the first business service system. The API module 150 also identifies a second business service system associated with the second business service identifier 172, access the API call list 156 associated with the second business service identifier 172 and retrieve a second API call 157 associated with the second business service identifier 172 and the second resource object 174, and transmit the second API call to the second business service system. The API module 150 is programmed to receive a first resource object data from the first business service system in response to the transmitted first API call, receive a second resource object data from the second business service system in response to the transmitted second API call, and transmit the received resource data object to the render module 148 to generate the return response including the first and the second resource object data to the client computing device 14.

In one embodiment, the API module 150 may be programmed to modify the second API call to include the first resource object data received from the first business service system and transmit the modified second API call to the second business service system. For example, in one embodiment, API module 150 may receive an HTTP request from a gaming machine that includes a HTTP POST request to post a notice to a player's Twitter™ account. The HTTP request includes a first resource request 164 including a request to receive a resource object including player account data including Twitter™ account information, and a second resource request 166 including a request to post a notification of a progressive award win to a Twitter™ account. The API module 150 transmits an API call to the player management server 126 including a that causes the player management server 126 to retrieve the player account information and transmit the player account information to the API module 150. The API module 150 then transmits an API call to the Twitter™ servers including the Twitter™ account information received from the player management server 126, which causes the Twitter™ server to post a notification on the player's Twitter™ website feed.

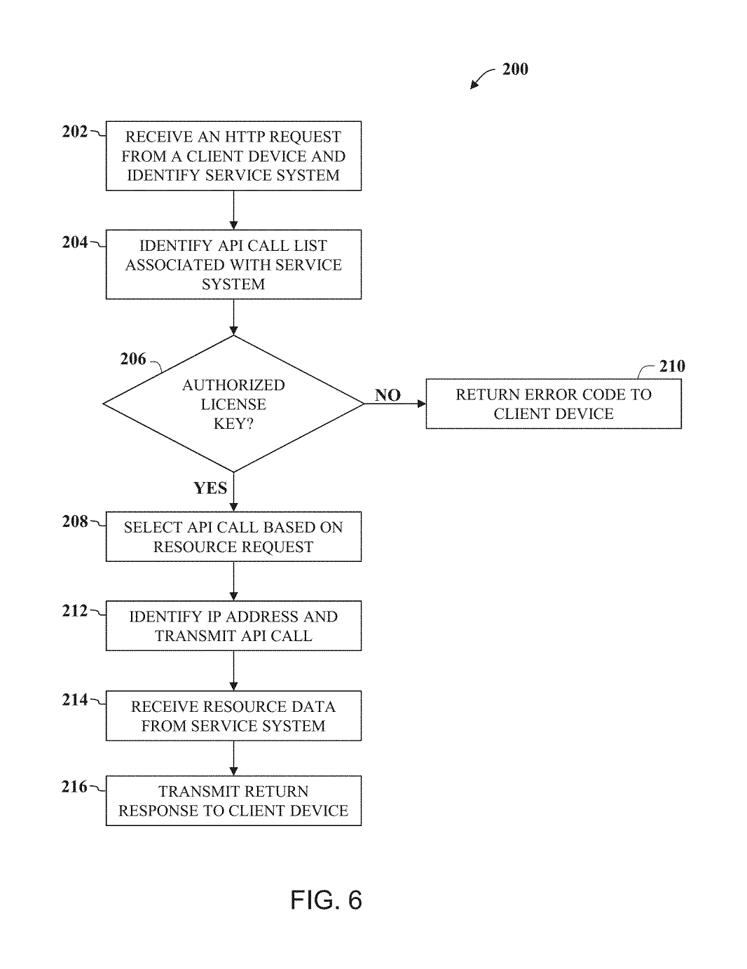

FIG. 6 is flowchart of method 200 that may be used to operate the system 10 to display a webpage on a client computing device. The method includes a plurality of steps. Each method step may be performed independently of, or in combination with, other method steps. Portions of the methods may be performed by any one of, or any combination of, the components of the system 10.

In method step 202, the API server computer 12 receives an HTTP request from a client computing device and identifies a business service system 16 and/or 3^{rd} party service as a function of the received HTTP request. For example, in one embodiment, the API server computer 12 may receive an HTTP request from a gaming machine 38 including a URL including a resource request including a business service identifier and a resource object. The API server computer 12 then identifies a business service system associated with the business service identifier included in the URL.

For example, referring to FIGS. 7-8, the gaming machine 38 may display the True Time Windows™ GUI on the gaming machine display including the player interaction screen 52 having a property services icon 118 associated with gaming property services being displayed in the non-gaming content section of the player interaction screen 52. Upon selection of the property services icon 118, the gaming machine 38 may access the HTTP list 26 (shown in FIG. 19) being stored in the gaming machine memory device, select the HTTP request 28 associated with the hotel services icon 118, and transmit the HTTP request to the API server computer 12. The API server computer 12 then identifies a business service system associated with the business service identifier included in the HTTP request.

In method step 204, the API server computer 12 accesses the API call library 154 upon receiving the HTTP request from the gaming machine and identifies an API call list 156 associated with the identified business service server.

In method step 206, the API server computer 12 determines if the HTTP request includes an authorized license key 36. For example, the API server computer 12 identifies a license key 36 included in the HTTP request, accesses the API authorization list 158 upon receiving the HTTP request 28, determines if the identified API call list 156 is associated with the identified license key 36. If the license key 36 is associated with the identified API call list 156, the API server computer 12 proceeds to method step 208 and selects an API call from the identified API call list 156. If the license key 36 is not associated with the identified API call list 156, the API server computer 12 determines that the API call list is not exposed to the identified license key 36 and implements method step 210 to return an error code to the gaming machine 38. For example, the error code may include, but is not limited to, an HTTP 404 Not Found Error code, an HTTP 403, or HTTP 401 error code.

In method step 208, upon determining the license key 36 is authorized to access the identified API call list 156, the API server computer 12 selects an API call from the identified API call list 156 as a function of the resource object 34 including the HTTP request. For example, the API server computer 12 accesses the identified API call list and selects the API call as a function of the resource request and transmit the selected API call to the identified business service server computer

In method step 212, the API server computer 12 accesses the IP address list 162 upon receiving the HTTP request, and identifies an IP address associated with the identified business service system, and transmits the selected API call 157 to the identified IP address associated with the identified business service system.

In method step 214, the API server computer 12 receives resource object data from the business service system and/or 3^{rd} party system receiving the API call.

In method step 216, the API server computer 12 generates a return response including the received resource object data and transmits the return response to the gaming machine including instructions that cause a web browser program of the gaming machine to generate HTML code for use in displaying a webpage including the resource object data on a display device of the gaming machine. For example, in one embodiment the API server computer receives the resource object data and executes a render operation to generate an HTML code string that is transmitted to the gaming machine 38 to generate and display a webpage including the resource object data. The API server computer 12 may also initiate a partial-render operation to generate partially-rendered application code including JavaScript instructions to generate the HTML code using the received resource object data, and transmit JavaScript instructions and the resource object data to the gaming machine 38.

For example, with reference to FIGS. 8-16, the API server computer 12 may include an API call library that includes an API call list that is used to obtain resource objects that may be used to generate HTML code string to display a plurality of webpages using different GUIs on different client computing devices 14. For example, the API server computer 12 may include an API call library that may be used to generate a True Time Window™ display 114, a casino webpage 176, a 3^{rd} party hotel reservation webpage 178, a 3^{rd} party show reservation webpage 180, a 3^{rd} party restaurant reservation webpage 182, a player management webpage 184, a gaming property statistics webpage 186, and/or any suitable webpage that may be used to access and display information generated by the business service systems 16 and/or the 3^{rd} party server systems 20.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. In addition, a central processing unit (CPU) may include one or more processors as described herein. The above examples are exemplary only, and thus are not intended to limit in any way the definition and/or meaning of the term processor.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor. Processors may execute one or more program applications, such as a web browser (e.g., Microsoft Internet Explorer, Mozilla Firefox, Apple Safari, Google Chrome, and Opera, etc.), to access and view content over a computer network. In particular implementations, the program applications allow a user to enter addresses of specific network resources to be retrieved, such as resources hosted by a networking system. These addresses can be Uniform Resource Locators, or URLs. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page. A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In some embodiments, a network, as describe herein, includes a network addressable system that, in various example embodiments, comprises one or more physical servers and data stores. The one or more physical servers are operably connected to a computer network via, by way of example, a set of routers and/or networking switches. In an example embodiment, the functionality hosted by the one or more physical servers may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like. Data stores may store content and data relating to, and enabling, operation of the networking system as digital data objects. A data object, in particular implementations, is an item of digital information typically stored or embodied in a data file, database or record. Content objects may take many forms, including: text (e.g., ASCII, SGML, HTML), images (e.g., jpcg, tif and gif), graphics (vector-based or bitmap), audio, video (e.g., mpeg), or other multimedia, and combinations thereof. Content object data may also include executable code objects (e.g., games executable within a browser window or frame), podcasts, etc. Data stores corresponds to one or more of a variety of separate and integrated databases, such as relational databases and object-oriented databases, that maintain information as an integrated collection of logically related records or files stored on one or more physical systems.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A casino data management system, comprising:
a plurality of business service systems, each business service system including a business service server computer coupled to a resource database; and
an API server computer coupled to each of the plurality of business service systems and to a plurality of gaming machines, each gaming machine including a processor coupled to memory device having a web browser program installed thereon, the API server computer including a processor coupled to a memory device including a data library stored thereon, the data library including a plurality of API calls associated with data resources stored in the plurality of business service systems, the API server computer configured to:
receive an HTTP request from at least one gaming machine, the HTTP request including a URL including a resource request including a business service identifier and a resource object;
identify a business service system associated with the business service identifier included in the URL and transmit an API call to the identified business service system as a function of the resource object;
receive resource object data from the identified business service system in response to the transmitted API call; and
generate and transmit a return response including the received resource object data to the at least one gaming machine, the return response including instructions that cause a web browser program of the at least one gaming machine to generate HTML code for use in displaying a webpage including the resource object data on a display device of the at least one gaming machine.

2. The system of claim 1, wherein the data library includes a set of API calls associated with each business service system, the API server computer configured to access the data library upon receiving the HTTP request from the gaming machine and select the API call as a function of the identified business service system.

3. The system of claim 2, wherein the data library includes an API call library including a plurality of API call lists, each API call list associated with a corresponding business service system, the API server computer configured to:
access the API call library upon receiving the HTTP request from the gaming machine and identify an API call list associated with the identified business service system; and
access the identified API call list and select the API call as a function of the resource request and transmit the selected API call to the identified business service system.

4. The system of claim 3, the API server computer configured to:
determine if the HTTP request includes a license key and access the API call list upon identifying the license key.

5. The system of claim 4, wherein the data library includes a API authorization list including a plurality of authorization records, each authorization record including a corresponding license key and one or more API call lists associated with the corresponding license key, the API server computer configured to:
access the API authorization list upon receiving the HTTP request and determine if the API call list is associated with the identified license key; and
transmit the selected API call upon determining the identified license key is associated with the selected API call list.

6. The system of claim 2, wherein the HTTP request includes a first resource request and a second resource request, the first resource request including a first business service identifier and a first resource object, the second resource request including a second business service identifier and a second resource object, the API server computer configured to:
identify a first business service system associated with the first business service identifier, retrieve a first API call associated with the first business service identifier and the first resource object, and transmit the first API call to the first business service system;
identify a second business service system associated with the second business service identifier, retrieve a second API call associated with the second business service identifier and the second resource object, and transmit the second API call to the second business service system;
receive a first resource object data from the first business service system in response to the transmitted first API call;
receive a second resource object data from the second business service system in response to the transmitted second API call; and
generate the return response including the first and the second resource object data to the gaming machine.

7. The system of claim 6, wherein the API server computer is configured to modify the second API call to include the first resource object data received from the first business service system and transmit the modified second API call to the second business service system.

8. The system of claim 1, wherein the data library includes a plurality of IP addresses associated with each business service system, the API server computer configured to:
access the data library upon receiving the HTTP resource request and identify an IP address associated with the identified business service system; and
transmit the API call to the identified IP address associated with the identified business service system.

9. A method operating a casino management system, the casino management system including a plurality of business service systems and an API server computer, each business service system including a business service server computer coupled to a resource database, the API server computer coupled to each of the plurality of business service systems and to a plurality of gaming machines, each gaming machine including a processor coupled to memory device having a web browser program installed thereon, the API server computer including a processor coupled to a memory device including a data library stored thereon, the data library including a plurality of API calls associated with data resources stored in the plurality of business service systems, the method including the API server computer performing the steps of:
receiving an HTTP request from at least one gaming machine, the HTTP request including a URL including a resource request including a business service identifier and a resource object;
identifying a business service system associated with the business service identifier included in the URL and transmitting an API call to the identified business service system as a function of the resource object;
receiving resource object data from the identified business service system in response to the transmitted API call; and
generating and transmitting a return response including the received resource object data to the at least one gaming machine, the return response including instructions that cause a web browser program of the at least one gaming machine to generate HTML code for use in displaying a webpage including the resource object data on a display device of the at least one gaming machine.

10. The method of claim 9, wherein the data library includes a set of API calls associated with each business service system, the method includes the API server computer performing the steps of:
accessing the data library upon receiving the HTTP request from the gaming machine and selecting the API call as a function of the identified business service system.

11. The method of claim 10, wherein the data library includes an API call library including a plurality of API call lists, each API call list associated with a corresponding business service system, the method including the API server computer performing the steps of:
accessing the API call library upon receiving the HTTP request from the gaming machine and identifying an API call list associated with the identified business service system; and
accessing the identified API call list and select the API call as a function of the resource request and transmitting the selected API call to the identified business service system.

12. The method of claim 11, including the API server computer performing the steps of:
determining if the HTTP request includes a license key and accessing the API call list upon identifying the license key.

13. The method of claim 12, wherein the data library includes a API authorization list including a plurality of authorization records, each authorization record including a corresponding license key and one or more API call lists associated with the corresponding license key, the method including the API server computer performing the steps of:
accessing the API authorization list upon receiving the HTTP request and determining if the API call list is associated with the identified license key; and
transmitting the selected API call upon determining the identified license key is associated with the selected API call list.

14. The method of claim 10, wherein the HTTP request includes a first resource request and a second resource request, the first resource request including a first business service identifier and a first resource object, the second resource request including a second business service identifier and a second resource object, the method including the API server computer performing the steps of:
identifying a first business service system associated with the first business service identifier, retrieving a first API call associated with the first business service identifier and the first resource object, and transmitting the first API call to the first business service system;
identifying a second business service system associated with the second business service identifier, retrieving a second API call associated with the second business service identifier and the second resource object, and transmitting the second API call to the second business service system;
receiving a first resource object data from the first business service system in response to the transmitted first API call;
receiving a second resource object data from the second business service system in response to the transmitted second API call; and
generating the return response including the first and the second resource object data to the gaming machine.

15. The method of claim 14, including the API server computer performing the steps of:
modifying the second API call to include the first resource object data received from the first business service system and transmitting the modified second API call to the second business service system.

16. The system of claim 9, wherein the data library includes a plurality of IP addresses associated with each business service system, the method includes the API server computer performing the steps of:
accessing the data library upon receiving the HTTP resource request and identifying an IP address associated with the identified business service system; and
transmitting the API call to the identified IP address associated with the identified business service system.

17. One or more non-transitory computer-readable storage media, having computer-executable instructions embodied thereon, wherein when executed by at least one processor, the computer-executable instructions cause the processor to function as:
an API server computer coupled to a plurality of business service systems and to a plurality of gaming machines, each gaming machine including a processor coupled to memory device having a web browser program installed thereon, the API server computer including a processor coupled to a memory device including a data library stored thereon, the data library including a plurality of API calls associated with data resources stored in the plurality of business service systems, the API server computer configured to:
receive an HTTP request from at least one gaming machine, the HTTP request including a URL including a resource request including a business service identifier and a resource object;
identify a business service system associated with the business service identifier included in the URL and transmit an API call to the identified business service system as a function of the resource object;
receive resource object data from the identified business service system in response to the transmitted API call; and
generate and transmit a return response including the received resource object data to the at least one gaming machine, the return response including instructions that cause a web browser program of the at least one gaming machine to generate HTML code for use in displaying a webpage including the resource object data on a display device of the at least one gaming machine.

18. The one or more non-transitory computer-readable storage media of claim 17, wherein the data library includes a set of API calls associated with each business service system, the API server computer configured to access the data library upon receiving the HTTP request from the gaming machine and select the API call as a function of the identified business service system.

19. The one or more non-transitory computer-readable storage media of claim 17, wherein the data library includes an API call library including a plurality of API call lists, each API call list associated with a corresponding business service system, the API server computer configured to:
access the API call library upon receiving the HTTP request from the gaming machine and identify an API call list associated with the identified business service system; and
access the identified API call list and select the API call as a function of the resource request and transmit the selected API call to the identified business service system.

20. The one or more non-transitory computer-readable storage media of claim 19, wherein the data library includes a API authorization list including a plurality of authorization records, each authorization record including a corresponding license key and one or more API call lists associated with the corresponding license key, the API server computer configured to:
determine if the HTTP request includes a license key, access the API authorization list upon receiving the HTTP request, determine if the API call list is associated with the identified license key; and
transmit the selected API call upon determining the identified license key is associated with the selected API call list.
